(19) United States
(12) Patent Application Publication
(10) Pub. No.: US 2015/0174840 A1
(43) Pub. Date: Jun. 25, 2015

(54) METHOD FOR AVOIDING ENTRAPMENT OF AIR BUBBLES IN A LENS FORMING MATERIAL AND APPARATUS FOR CARRYING OUT THE METHOD

(71) Applicant: Novartis AG, Basel (CH)

(72) Inventors: Gabriela Cocora, Elsenfeld-Eichelsbach (DE); Halina Heidrich, Kahl am Main (DE); Lukas Lomb, Mainaschaff (DE); Thomas Tonn, Aschaffenburg (DE); Fabian Kern, Amorbach (DE)

(21) Appl. No.: 14/573,513

(22) Filed: Dec. 17, 2014

Related U.S. Application Data
(60) Provisional application No. 61/918,128, filed on Dec. 19, 2013.

(51) Int. Cl. B29D 11/00

(52) U.S. Cl. CPC B29D 11/00125; B29D 11/0048; B29D 11/00038; B29K 2909/08

(57) ABSTRACT

A method for avoiding the entrapment of air bubbles (5) in a lens forming material (4), in particular in a low viscosity lens forming material, in an ophthalmic lens manufacturing process using mold halves (2, 3) each having a lens forming surface (21, 31) comprises electrostatically charging (60) a lens forming surface (21, 31) of the mold half (2, 3) prior to the lens forming surface (21, 31) coming into contact with the lens forming material (4).

This application claims the benefit under 35 USC §119 (e) of U.S. provisional application Ser. No. 61/918,128 filed Dec. 19, 2013, incorporated herein by reference in its entirety.

### FIELD

The invention relates to a method for avoiding entrapment of air bubbles in a lens forming material, in particular in a low viscosity lens forming material, in an ophthalmic lens manufacturing process, for example in a contact lens manufacturing process, and to an apparatus for carrying out the method.

### BACKGROUND

Contact lenses, in particular soft contact lenses for single use, are nowadays produced in great volumes in highly automated manufacturing processes and facilities. These contact lenses can be manufactured using reusable male and female mold halves which are typically made of glass. When mated to form the mold these mold halves define a hollow mold cavity between the lens forming surfaces of the male and female mold halves, and this lens cavity corresponds to the shape of the contact lens to be formed. Prior to mating the male and female mold halves to close the mold a lens forming material which may be a polymer or pre-polymer solution is dosed into the female mold half. Suitable lens forming materials include polymers or pre-polymers based on polyvinyl alcohols (PVA), on silicone hydrogels (SiHy) or on polyethylene glycols (PEG), or other suitable lens forming materials as are known in the art. After closing the mold, the lens forming material contained in the mold cavity is cured through polymerization and/or cross-linking to form the contact lens.

During manufacturing of such contact lenses it may occur, that air bubbles get entrapped in the lens forming material. For example, such entrapment of air bubbles may occur in a boundary region of the lens forming material and the lens forming surface of the female mold half as the lens forming material is dispensed into the female mold half. Such entrapment may in particular occur when a lens forming material having a high viscosity is used. In case such highly viscous lens forming material is dispensed into the female mold half at the center of the female mold half, the surface of the female mold half may not get properly wetted and air bubbles may get entrapped which may not escape during further wetting of the lens forming surface. To avoid this, the material can be dispensed into the female mold half off-center. Another possibility of air bubble entrapment is at the boundary surface of the lens forming material and the male mold half as the male mold half is mated with the female mold half to close the mold. This may in particular occur with a lens forming material having a low viscosity (but may also occur with a highly viscous lens forming material). It is believed that the formation of air bubbles may be the result of a non-uniform and/or non-symmetric wetting of the respective mold half by the lens forming material. For example, as the male mold half is advanced towards the lens forming material contained in the female mold half, in case the first contact of the lens forming surface of the male mold half does not occur at a predefined single point this may result in a non-homogeneous wetting of the lens forming surface of the male mold half and to the entrapment of air bubbles. The entrapped air bubbles may lead to a poor lens quality, thus resulting in rejection of the contact lens.

### SUMMARY

It is therefore an object of the invention to provide a remedy to the afore-mentioned problems of air bubble entrapment. To achieve this, in accordance with a first aspect the present invention suggests a method for avoiding the entrapment of air bubbles in a lens forming material as it is specified in the independent method claim. Embodiments of the method according to the invention are the subject of the dependent claims.

In particular, the method for avoiding entrapment of air bubbles in a lens forming material, in particular in a low viscosity lens forming material, in an ophthalmic lens manufacturing process using mold halves each having a lens forming surface includes the step of providing an electrostatic charge on a lens forming surface of at least one of said mold halves prior to said lens forming surface coming into contact with said lens forming material.

In some embodiments of the method according to the invention, said at least one mold half is a female mold half comprising a concavely shaped lens forming surface, and said electrostatic charge is provided on said concavely shaped lens forming surface of said female mold half prior to dispensing said lens forming material into said female mold half.

In some further embodiments of the method according to the invention, said at least one mold half is a male mold half comprising a convexly shaped lens forming surface, and said electrostatic charge is provided on said convexly shaped lens forming surface of said male mold half prior to advancing said male mold half towards a female mold half containing said lens forming material for mating said male and female mold halves.

In still some further embodiments of the method according to the invention, said electrostatic charge is provided on said lens forming surface of said at least one mold half by arranging said lens forming surface of said at least one mold half for a predetermined charging time interval at a predetermined distance from a charging electrode with said lens forming surface facing towards said charging electrode, with a DC voltage of a predetermined magnitude being applied to said charging electrode to cause said electrostatic charge to be provided on said lens forming surface of said at least one mold half.

In accordance with one aspect of the method according to the invention, said predetermined charging time interval is in the range of 0.1 s to 0.5 s, said predetermined distance from said charging electrode is in the range of 10 mm to 20 mm, and said predetermined magnitude of said DC voltage is in the range of 6 kV to 12 kV.

In some embodiments of the method according to the invention, prior to arranging said lens forming surface for said predetermined charging time interval at said predetermined distance from said charging electrode, said lens forming surface is arranged for a predetermined discharging time interval at a predetermined distance from a discharging electrode with said lens forming surface facing towards said discharging electrode, with an AC voltage of a predetermined magnitude being applied to said discharging electrode to cause any electrostatic charges present on said lens forming surface to be removed from said lens forming surface.

In accordance with one aspect of the method according to the invention, said predetermined discharging time interval is in the range of 0.01 s to 0.05 s, wherein said predetermined distance from said discharging electrode is in the range of 20 mm to 30 mm, and wherein said predetermined magnitude of said AC voltage is in the range of 4 kV to 10 kV.

In some embodiments of the method according to the invention, during or after providing said electrostatic charge on said convexly shaped lens forming surface of said male mold half said lens forming material is dispensed into said female mold half. Said male mold half is then advanced towards said female mold half to close said mold, and said closed mold is then arranged for a predetermined mold discharging time interval at a predetermined distance from a further discharging electrode with said closed mold facing towards said further discharging electrode, with an AC voltage of a predetermined magnitude being applied to said further discharging electrode to cause any electrostatic charges present on said closed mold to be removed from said closed mold.

In some further embodiments of the method according to the invention, said charging electrode comprises an elongated charging bar having a plurality of charging tips arranged along the longitudinal extension of said charging bar and projecting therefrom, and the at least one mold half is moved along the longitudinal extension of said charging bar with the lens forming surface of said at least one mold half facing towards the charging tips of said charging bar.

In still some further embodiments of the method according to the invention, the discharging electrode and/or the further discharging electrode, respectively, comprises an elongated discharging bar having a plurality of discharging tips arranged along the longitudinal extension of said elongated discharging bar. The at least one mold half or said closed mold, respectively, are moved along the longitudinal extension of said elongated discharging bar of said discharging electrode or of said further discharging electrode, respectively, with said lens forming surface of said at least one mold half or said closed mold facing towards the discharging tips of said elongated discharging bar of said discharging electrode or of said further discharging electrode, respectively.

In yet some further embodiments of the method according to anyone of the preceding embodiments described, said at least one mold half is made of glass, preferably of quartz glass.

In accordance with a second aspect, the present invention suggests an apparatus for carrying out the afore-described method, this apparatus being specified in the independent apparatus claim.

In particular, the apparatus for carrying out the method according to the invention comprises a charging electrode and at least one mold half having a lens forming surface, said charging electrode and said lens forming surface being arranged relative to each other in a manner such that during a predetermined charging time interval said lens forming surface is arranged at a predetermined distance from said charging electrode with said lens forming surface facing towards said charging electrode, with a DC voltage of a predetermined magnitude being applied to said charging electrode to cause said electrostatic charge to be provided on said lens forming surface of said at least one mold half.

Some embodiments of the apparatus according to the invention are including a carrier for said at least one mold half, a transport system for moving the carrier, and a discharging electrode, the discharging electrode being arranged upstream of said charging electrode with respect to a direction of transport of said carrier with said transport system, with an AC voltage being applied to said discharging electrode. Said discharging electrode is arranged in a manner such that, during transport of said carrier said lens forming surface is arranged during a predetermined discharging time interval at a predetermined distance from said discharging electrode, with said lens forming surface facing said discharging electrode to cause any electrostatic charges present on said lens forming surface to be removed from said lens forming surface, and that during further transport of said carrier said lens forming surface is arranged during said charging time interval at said predetermined distance from said charging electrode, with said lens forming surface facing towards said charging electrode to cause said electrostatic charge to be provided on said lens forming surface.

Some further embodiments of the apparatus according to the invention are including a further discharging electrode which is arranged downstream of said charging electrode with respect to said direction of transport of said carrier with said transport system, with an AC voltage being applied to said further discharging electrode. Said further discharging electrode is arranged in a manner such that after providing said electrostatic charge on said lens forming surface on said at least one mold half and after mating said at least one mold half with the electrostatic charge provided thereon with an associated further mold half to form a closed mold, the closed mold is arranged during a predetermined mold discharging time interval at a predetermined distance from said further discharging electrode, with said closed mold facing towards said further discharging electrode to cause any electrostatic charge to be removed from the closed mold.

By providing an electrostatic charge on the lens forming surface of at least one of the mold halves and moving the mold halves towards each other, a controlled point of first contact of the lens forming material with the lens forming surface of the said mold half is ascertained. The electrostatic charge on the lens forming surface, which can be a positive or a negative charge, and the relative movement of the polar molecules of the lens forming material in the (inhomogeneous) electrical field generated by the electrostatic charge result in an attraction force on the (polar) lens forming material to the said lens forming surface. Thus, the point of first contact of the lens forming surface with the lens forming material can be controlled, as will be explained in more detail below. From this point of first contact the lens forming material spreads across the lens forming surface, thereby avoiding any arbitrary additional points of first contact of the lens forming material with the lens forming surface which may include the risk of entrapment of air bubbles.

While the invention is advantageous with respect to both high viscosity lens forming materials, i.e. lens forming materials having a viscosity in the range of 1000 mPas to 10000 mPas (for example, 1400 mPas to 3000 mPas), and low viscosity lens forming materials, i.e. lens forming materials having a viscosity in the range of 0.5 mPas to 100 mPas (for example, 20 mPas to 27 mPas), it is particularly advantageous with respect to low viscosity lens forming materials.

For low viscosity lens forming materials, bubbles formed upon dispensing the lens forming material into the female mold half (“dosing bubbles”) are not so much a problem since the lens forming material quickly and automatically spreads over the lens forming surface of the female mold half, in particular if the lens forming material is dispensed into the female mold half off-center. However, bubbles may occur during mating of the male and female mold halves as the male mold half approaches the female mold half, since due to the closely corresponding shapes of the lens forming surfaces of the male and female mold halves the lens forming material at the same time may make first contact with the lens forming surface of the male mold half at various locations (points). From these various points of first contact the lens forming material spreads over the lens forming surface of the male mold half and where the spreading lens forming material meets bubbles may be included (“forming bubbles”). Such “forming bubbles” can be avoided by the provision of an electrostatic charge on the lens forming surface of the male mold half. The electrostatic charge on the lens forming surface of the male mold half and the convex shape of the lens forming surface of the male mold half generate an inhomogeneous electrical field between the lens forming surface of the male mold half and the lens forming material, this inhomogeneous electrical field being strongest at the center of the male mold half. As the male mold half approaches the female mold half during mating of the male and female mold halves, the forces generated by the relative movement of the (polar) molecules of the lens forming material in the inhomogeneous electrical field of the electrostatic charge and acting on the lens forming material are highest at the center of the male mold half (due to the inhomogeneous field being strongest at the apex of the male mold half). This results in a controlled first point of contact between the lens forming material and the lens forming surface of the male mold half at the center of the male mold half. From this first point of contact the lens forming material uniformly spreads across the lens forming surface of the male mold half, thus avoiding the inclusion of bubbles.

For high viscosity lens forming materials, the “dosing bubbles” can be avoided by the provision of an electrostatic charge on the lens forming surface of the female mold half. As the droplet of the lens forming material is discharged from the tip of a dosing needle and approaches the lens forming surface, the droplet deforms at its lowermost point due to the forces acting thereon which are caused by the electrical field generated between the electrostatic charge provided on the lens forming surface and the lens forming material (droplet). Again this results in a first point of contact at the center of the female mold half, and from this first point of contact the lens forming material uniformly spreads across the lens forming surface of the female mold half, thus avoiding the inclusion of bubbles.

While the above scenarios suggest the provision of the electrostatic charge on the male mold half or the female mold half, it goes without saying that the electrostatic charge can be provided on the lens forming surfaces of both the male and female mold halves, both for low viscosity lens forming materials as well as for high viscosity lens forming materials.

Providing the electrostatic charge on the lens forming surface can be performed with the aid of a charging electrode to which a DC voltage of a predetermined magnitude is applied by arranging the lens forming surface for a predetermined charging time interval at a predetermined distance from said charging electrode. The magnitude of the DC voltage, the distance from the charging electrode and the charging time interval can be selected in accordance with the desired amount of electrostatic charge to be provided on the lens forming surface of the mold half, and in accordance with the type of charging electrode used as well as in accordance with the material the mold half is made of. One example is a charging time interval in the range of 0.1 to 0.5 s (seconds) at a predetermined distance in the range of 10 mm to 20 mm (millimeters), with a magnitude of the DC voltage in the range 6 kV to 12 kV (kilovolts). A suitable material for the mold half or mold halves is glass, especially quartz glass.

Providing the electrostatic charge on the lens forming surface can be performed with the charging electrode and the lens forming surface being fixedly arranged relative to one another. Advantageously, the electrostatic charge can also be provided on the lens forming surface during transport of the lens mold relative to the charging electrode with the lens forming surface facing towards the charging electrode. For that purpose, a charging electrode which comprises an elongated charging bar having a plurality of charging tips arranged along the longitudinal extension of the charging bar and projecting therefrom may be advantageous. One or more molds can then be transported under the elongated charging bar in the direction of the longitudinal extension thereof, with the lens forming surface of the respective mold or molds facing towards the charging tips.

To reliably start charging of the lens forming surface with the lens forming surface being fully discharged, prior to arranging the lens forming surfaces for the predetermined charging time interval at the predetermined distance from the charging electrode the lens forming surfaces may be arranged for a predetermined discharging time interval at a predetermined distance from a discharging electrode with the lens forming surfaces facing towards the discharging electrode. An AC voltage of a predetermined magnitude is applied to the discharging electrode to cause any potential charges on the lens forming surface to be removed from the lens forming surface by the alternating electrical field.

Again, the magnitude of the AC voltage, the distance from the discharging electrode, and the discharging time interval can be selected so as to reliably remove any charges from the lens forming surface, and can further be selected in accordance with the type of discharging electrode used as well as in accordance with the material the mold half is made of. One example is a discharging time interval in the range of 0.01 to 0.05 s (seconds) at a predetermined distance in the range of 20 mm to 30 mm (millimeters), with a magnitude of the AC voltage in the range of 4 kV to 10 kV (kilovolts). As mentioned already, a suitable material for the mold half or mold halves is glass, especially quartz glass.

Removing any electrostatic charge from lens forming surface can be performed with the discharging electrode and the lens forming surface being fixedly arranged relative to one another. Advantageously, the removal of any electrostatic charge from the lens forming surface can be performed during transport of the mold half or mold halves relative to the discharging electrode with the lens forming surface facing towards the discharging electrode. For that purpose, a discharging electrode comprising an elongated discharging bar having a plurality of discharging tips arranged along the longitudinal extension of the discharging bar and projecting therefrom may be advantageous. One or more molds can then be transported under the elongated discharging bar in the direction of the longitudinal extension thereof, with the lens forming surface of the respective mold or molds facing towards the discharging tips. The discharging bar is arranged upstream of the charging bar. After having been properly discharged, the mold half with the discharged lens forming surface may then be transported towards the charging electrode so as to provide the electrostatic charge on the lens forming surface, as this has been described above. Also, even if one of the mold halves is not to be provided with an electrostatic charge the lens forming surface of this mold half is preferably discharged as well so that no electrostatic charge is provided thereon. For example, the female mold half may not be provided with an electrostatic charge (but is nevertheless discharged) while an electrostatic charge is provided only to the male mold half. This may be preferably when using low viscosity lens forming materials.

After having provided the electrostatic charge on the lens forming surface and after the mold is closed, in case any electrostatic charge is present on the closed mold—for example, on plastic parts to which the glass mold half may be mounted—a further discharging electrode may be provided. The closed mold is then arranged for a predetermined mold discharging time interval at a predetermined distance from that further discharging electrode. A predetermined AC voltage applied to the further discharging electrode then removes any electrostatic charge which may be present on the closed mold. Again it is possible for this discharging of the mold to occur with the discharging electrode and lens forming surface being fixedly arranged relative to one another. Advantageously, the removal of any electrostatic charge from the closed mold can be performed during transport of the closed mold or closed molds relative to the further discharging electrode with the closed mold or closed molds facing towards the further discharging electrode. For that purpose, a further discharging electrode comprising an elongated discharging bar having a plurality of discharging tips arranged along the longitudinal extension of the discharging bar and projecting therefrom may be advantageous. One or more molds can then be transported under the elongated discharging bar in the direction of the longitudinal extension thereof, with the lens forming surface of the respective mold or molds facing towards the discharging tips. The further discharging bar is arranged downstream of the charging bar and downstream of the mold closing station.

### BRIEF DESCRIPTION OF THE DRAWINGS

Further details and advantages of the invention become apparent from the following description of embodiments thereof, reference being made to the drawings in which:

FIGS. 1-3 show three consecutive stages of mating a female and a male mold half of a contact lens mold during closing of the mold in a conventional contact lens manufacturing process, with the female mold half containing a lens forming material;

FIGS. 4-6 show the three consecutive stages of mating a female and a male mold half of FIGS. 1-3 after electrostatic charges have been provided on the lens forming surface of the male mold half;

FIGS. 7-9 show three consecutive stages of dispensing a lens forming material into a female mold half in a conventional contact lens manufacturing process;

FIGS. 10-12 show the three consecutive stages of dispensing a lens forming material into a female mold half to the lens forming surface of which electrostatic charges have been provided; and

FIGS. 13 shows an embodiment of the invention in which the male and female mold halves are discharged first, in which the male mold half is charged thereafter, and in which the closed mold is subsequently discharged.

### DETAILED DESCRIPTION OF EMBODIMENTS

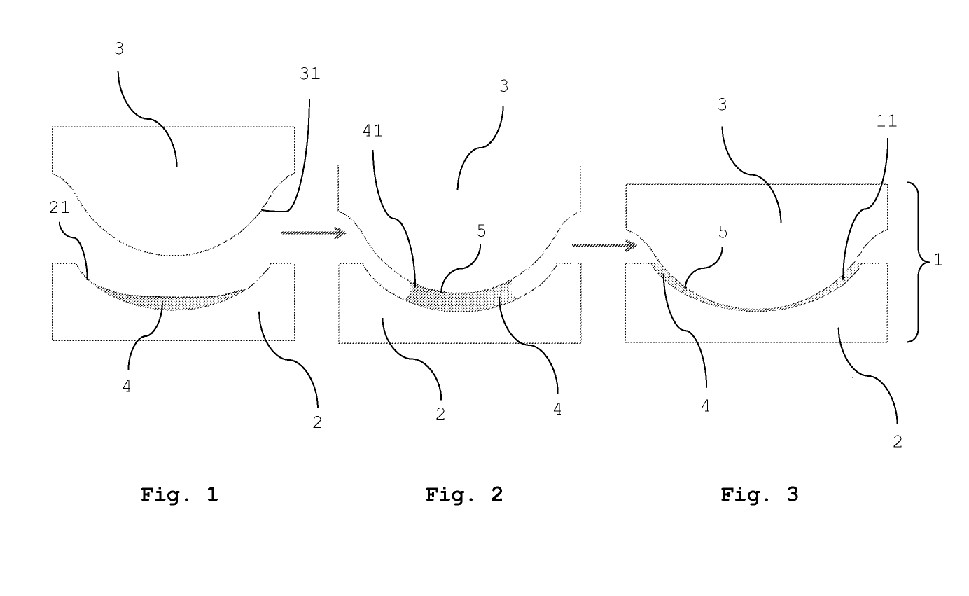

In FIGS. 1-3 three consecutive stages of mating a female and a male mold half in a conventional contact lens manufacturing process are shown. Female mold half 2 and male mold half 3 together form a lens mold 1. Female mold half 2 comprises a concavely shaped lens forming surface 21 determining the shape of a front surface of a contact lens to be molded. Correspondingly, male mold half 3 comprises a convexly shaped lens forming surface 31 determining the shape of the back surface of the contact lens to be molded. In the closed state of lens mold 1 the concavely shaped lens forming surface 21 and the convexly shaped lens forming surface 31 delimit a mold cavity 11. It is to be noted that for the sake of simplification in the drawings any means or measures for determining the shape of the edges of the contact lenses to be molded are not shown because they are not important for the understanding of the instant invention. At least the concavely shaped lens forming surface 21 and the convexly shaped lens forming surface 31, but preferably the entire female mold half 2 and the entire male mold half 3 are made of glass, for example from quartz glass or BK7 (commercially available from the company Schott, Germany).

FIG. 1 shows a stage in which a lens forming material 4 has already been dispensed into the female mold half 2 and is contained in the female mold half 2, immediately prior to advancement of the male mold half 3 towards the female mold half 2. FIG. 2 shows a stage in which the male mold half 2 has been advanced towards the female mold half 2 to an extent that the lens forming material 4 is in contact with the convexly shaped lens forming surface 31 of the male mold half. As can be seen, in a boundary region 41 of the lens forming material 4 and the convexly shaped lens forming surface 31 of the male mold half 3 air bubbles 5 may be entrapped. As already explained above, the formation of these air bubbles 5 (“forming bubbles”) may be the result of a non-controlled, multiple (i.e. non-single) point of first contact of the lens forming material 4 with the convexly shaped lens forming surface 31. FIG. 3 shows a stage in which the male mold half 3 and the female mold half 2 (and thus the mold 1) are closed. The lens forming material 4 completely fills mold cavity 11. The air bubbles 5 entrapped in the lens forming material 4 have been displaced towards a peripheral region of the mold cavity 11, however, they are not destroyed during the following curing of the lens forming material through polymerization and/or cross-linking of the lens forming material 4, so that they remain included in the final contact lens. This is not acceptable and, as a consequence, the lens with the entrapped air bubbles will be rejected during inspection of the contact lens.

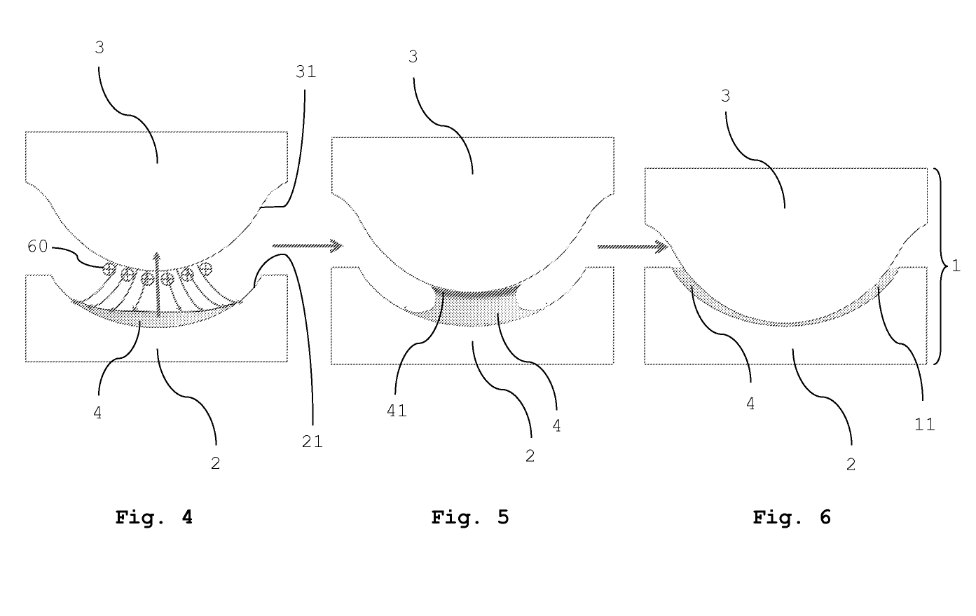

In FIGS. 4-6 three consecutive stages of mating the male mold half 3 with the female mold half 2 are illustrated, however, with an electrostatic charge 60 being provided on the convexly shaped lens forming surface 31 of the male mold half 3.

FIG. 4 shows a stage in which a lens forming material 4 has already been dosed into and is contained in the female mold half 2, immediately prior to advancement of the male mold half 3 towards the female mold half 2. As already mentioned, the convexly shaped lens forming surface 31 of male mold half 3 now carries an electrostatic charge 60, which in the embodiment shown is a positive electrostatic charge (but may alternatively be a negative electrostatic charge). Due to the forces generated by the relative movement of the (polar) lens forming material in the inhomogeneous electrical field of the positive electrostatic charge on the convexly shaped lens forming surface 31, and further due to the central portion (around and including the apex) of the convexly shaped lens forming surface 31 having the smallest distance to the lens forming material 4, the first contact of the lens forming material is controlled to occur at the center of the convexly shaped lens forming surface 31. This can be seen best in FIG. 5. Once the male mold half 3 and the female mold half 2 have been advanced together close enough, wetting of the male lens forming surface 31 starts from a single, well-defined first point of contact (or from a very small continuous area of first contact) and is continued uniformly across the convexly shaped lens forming surface 31 of male mold half 3, with no entrapment of air bubbles occurring in the boundary region 41 of the lens forming material 4 and the convexly shaped lens forming surface 31 of the male mold half 3. FIG. 6 finally shows a stage in which the mold 1 is fully closed. The lens forming material 4 completely fills the mold cavity 11 and is ready for being cured to form the contact lens.

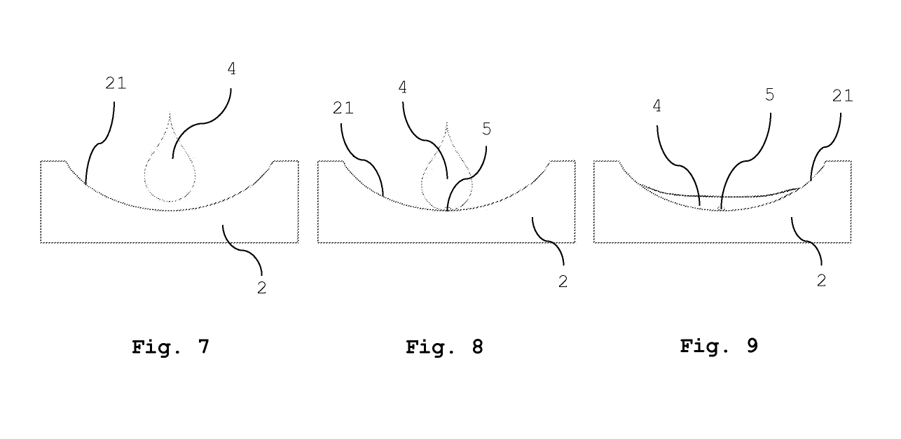

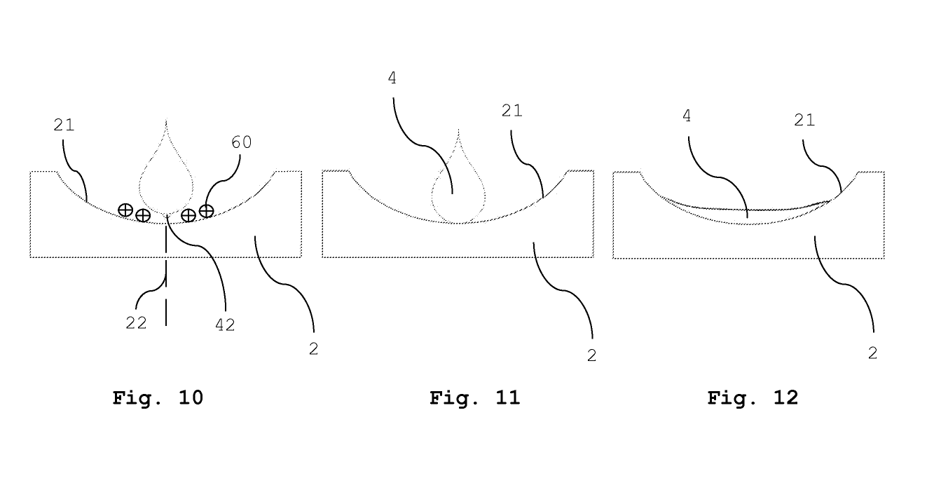

It has been explained already above, that in accordance with a further embodiment an electrostatic charge can be provided on a concavely shaped lens forming surface 21 of the female mold half 2. Three consecutive stages of dispensing a lens forming material 4 into a female mold half 2 are shown in FIGS. 7-9 without an electrostatic charge being provided on the concavely shaped lens forming surface 21 of the female mold half 2, while FIGS. 10-12 show the same three consecutive stages of dispensing a lens forming material 4 into a female mold half 2, however, with an electrostatic charge being provided on the concavely shaped lens forming surface 21 of the female mold half 2 prior to dispensing the lens forming material 4 into the female mold half 2.

FIG. 7 shows the lens forming material 4 just before it reaches the (uncharged) center (or central portion) of the concavely shaped lens forming surface 21 of female mold half 2. FIG. 8 shows the lens forming material 4 at that moment when it reaches the central portion of the concavely shaped lens forming surface 21. Since the first contact of the lens forming material 4 may not necessarily occur at a single point, and since consequently the lens forming material may not uniformly spread across the concavely shaped lens forming surface 21, one or more air bubbles 5 (only one being shown in FIG. 11) may be entrapped at a boundary region of the lens forming material 4 and the concavely shaped lens forming surface 21. FIG. 9 finally shows the situation when the lens forming material has wetted and spreads across the female lens forming surface 21. The entrapped air bubble 5 (“dosing bubble”) remains in place and is included in the contact lens once the lens forming material 4 has been cured to form the contact lens. This is not acceptable and results in the lens being rejected after inspection. The afore-described scenario is more likely to occur with lens forming materials 4 having a high viscosity than with lens forming materials having a low viscosity, but may nevertheless occur with lens forming materials having a low viscosity. In order to avoid entrapment of such air bubbles the lens forming material has been dispensed into the female mold half off-center. And while dispensing of the lens forming material into the female mold half off-center results in an improved yield there may still be occurrences where such air bubbles are included in the final contact lenses so that these contact lenses are rejected during inspection.

FIG. 10 (similar to FIG. 7) shows the lens forming material 4 just before it reaches the central portion of the concavely shaped lens forming surface 21 of the female mold half 2. This time, however, a positive electrostatic charge 60 is provided on the central portion of the concavely shaped lens forming surface 21 prior to dispensing the lens forming material 4 into the female mold half 2. The positive electrostatic charge exerts a force on the (polar) lens forming material 4 which results in a slight deformation of the lens forming material 4 (small deformation at the lowermost apex of the droplet, the deformation being shown exaggeratedly large in FIG. 10 for the sake of clarity). This results in the first contact of the lens forming material 4 with the lens forming surface 21 occurring at the center of the lens forming surface 21 of the female mold half, and subsequently leads to a symmetrical and uniform spreading of the lens forming material across the concavely shaped lens forming surface 21 starting at the center of the concavely shaped lens forming surface 21. As can be seen best in FIG. 11, no air bubbles are included as the lens forming material 4 starts to spread across the concavely shaped lens forming surface 21. FIG. 12 finally shows the lens forming material 4 after it has evenly spread across the female lens forming surface 21 of the female mold half 2 and before the male mold half is advanced towards it for closing the mold and for subsequent curing of the lens forming material to form the contact lens.

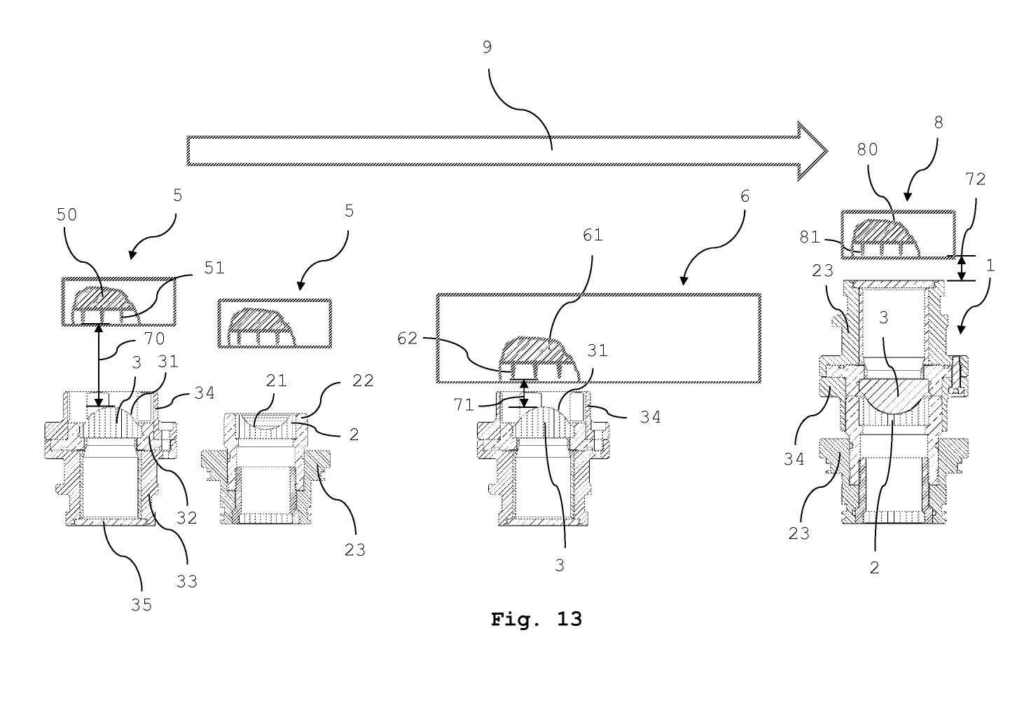

In FIG. 13 a specific embodiment of the method and apparatus according to the invention is shown. The direction of the process flow is represented by the arrow 9. As can be seen when glancing at the left hand side of FIG. 13, initially the convex lens forming surface 31 of male mold half 3 is arranged beneath (or passes beneath) a discharging electrode 5. The male mold half 3 is arranged in a mount 32 which itself is clamped between a metal sleeve 33 and a plastic sleeve 34. The discharging electrode 5 comprises an elongated discharging bar 50 which has a plurality of discharging tips 51 arranged along the longitudinal extension of the discharging bar 50 and projecting therefrom. The lens forming surface 31 (the apex thereof) of the male mold half 3 is arranged at a predetermined distance 70 from the discharging tips 51 of the discharging bar 50. For example, the discharging electrode 5 may be of the type EI VS available from the company Haug GmbH & Co. KG, Leinfelden-Echterdingen, Germany, which generates an AC voltage in the range of 4 kV-10 kV (kilovolts). The power supply (discharging generator) may be of the type EN SL SD, available from the same company. The discharging electrode may have a length (longitudinal extension) in the range of 30 mm to 100 mm (millimeters), and the predetermined distance 70 may be in the range of 20 mm-30 mm. For example, the male mold half 3 (together with the equipment mounted thereto) may pass beneath the discharging electrode 5 along the longitudinal extension thereof with a transport speed which is in the range of 1 m/s and 2 m/s (meters per second). Since the transport speed may not be uniform (it may have an accelerating phase and a decelerating phase), the predetermined discharging time interval (the time interval of exposure of the lens forming surface 31 to the discharging electrode 5) in this embodiment is in the range of 10 ms to 50 ms (milliseconds).

Similar considerations hold for the female mold half 2 which is arranged in a mount 22 which itself is held in a metal sleeve 23. It is passed beneath a discharging electrode 5 of the same type having a discharging bar 50 and a plurality of discharging tips 51 projecting therefrom. The ranges for the discharging time interval, the distance 70 of the concave lens forming surface 21 from the discharging tips 51 of the electrode 5, and the transport speed with which the lens forming surface 21 is passed under the discharging electrode 50 of the female mold half 2 are the same as for the lens forming surface 31 of the male mold half 3. Also, the same type of discharging electrode 5 can be used.

The (alternating) electrical field generated by the AC voltage removes any electrostatic charge from the lens forming surface 31 of the male mold half 3, and similarly removes any electrostatic charge from the lens forming surface 21 of the female mold half 2. Thereafter, the lens forming surface 31 of the male mold half 3 and the lens forming surface 21 of the female mold half 2 are in a well-defined discharged state, and these starting conditions are identical for all mold halves which have passed beneath the discharging electrodes 5.

In the further flow of the process (see arrow 9) the lens forming surface 31 of the male mold half is arranged beneath a charging electrode 6. The charging electrode 6 comprises an elongated charging bar 61 which has a plurality of charging tips 62 arranged along the longitudinal extension of the charging bar 61. The lens forming surface 31 (the apex thereof) of the male mold half 3 is arranged at a predetermined distance 71 from the charging tips 62 of the charging bar 61. For example, the charging electrode 6 may be of the type ALW available from the company Haug GmbH & Co. KG, Leinfelden-Echterdingen, Germany, which generates a DC voltage in the range of 6 kV-12 kV (kilovolts). The power supply (charging generator) may be of the type AGW, available from the same company. The charging electrode may have a length (longitudinal extension) in the range of 200 mm to 300 mm (millimeters), and the predetermined distance 71 may be in the range of 10 mm-20 mm. For example, the male mold half (together with the equipment mounted thereto) may pass beneath the charging electrode 6 along the longitudinal extension thereof with a transport speed which is in the range of 1 m/s and 2 m/s (meters per second). The predetermined charging time interval (the time interval of exposure of the lens forming surface 31 to the charging electrode 6) is in the range of 100 ms to about 500 ms (milliseconds). Accordingly, an electrostatic charge, in the embodiment shown a positive electrostatic charge 60 (see FIG. 4), is thus provided on the lens forming surface 31 of the male mold half 3. Also, in the embodiment shown during transport of the male mold half 3 (together with the equipment mounted thereto) some electrostatic charge may also be provided on the plastic sleeve 34. In the embodiment shown, the female mold half 2 is not arranged or passed beneath the charging electrode 6 and, accordingly, no electrostatic charge is provided on the lens forming surface 21 of the female mold half 2.

A lens forming material 4 (see FIG. 4), for example a low viscosity lens forming material, is then dispensed into the female mold half 2, and the mold 1 is then closed by mating the male mold half 3 and the female mold half 2. A contact lens is then formed, for example by exposing the lens forming material 4 contained in the mold cavity 11 (see FIG. 6) to radiation, for example to UV-radiation, which may irradiate the lens forming material 4 through a glass plate 35 mounted to the metal sleeve 33. Once the contact lens has been formed, the mold must be opened and the contact lens removed. However, before opening the mold any electrostatic charge present on the mold must be removed. In particular, the electrostatic charge present on the plastic sleeve 34 of the equipment to which the male mold half 3 is mounted must be removed.

For that purpose, the closed mold together with the equipment mounted thereto is arranged beneath a further discharging electrode 8. The further discharging electrode 8 comprises an elongated discharging bar 80 which has a plurality of discharging tips 81 arranged along the longitudinal extension of the discharging bar 80 and projecting therefrom. The mold is arranged at a predetermined distance 72 from the discharging tips 81 of the discharging bar 80. For example, the further discharging electrode 8 may again be of the type EI VS available from the company Haug GmbH & Co. KG, Leinfelden-Echterdingen, Germany, which generates an AC voltage in the range of 7 kV-8 kV (kilovolts). The power supply (discharging generator) may be of the type EN SL SD, available from the same company. The further discharging electrode may again have a length (longitudinal extension) in the range of 30 mm to 100 mm (millimeters). In the embodiment shown, the closed mold has a length of 63 mm in total and is arranged at a predetermined distance 72 of 12 mm from the upper end of the closed mold. On the metallic sleeve 33 of the male mold 3 there is no electrostatic charge, however, on the plastic sleeve 34 there is typically some electrostatic charge which has been provided thereon during providing the electrostatic charge on the lens forming surface 31 of the male mold half 3. For an operating range of 10 mm-80 mm (millimeters) for the distance of the mold from the further discharging electrode 8, the entire mold 1 is arranged within the said operating range of the further discharging electrode 8. For example, the mold (together with the equipment mounted thereto) may pass beneath the further discharging electrode 8 along the longitudinal extension thereof with a transport speed which is in the range of 1 m/s and 2 m/s (meters per second). Accordingly, the predetermined mold discharging time interval (the time interval of exposure of the lens forming surface 31 to the alternating electric field generated by the further discharging electrode 8) in this embodiment is in the range of 10 ms to 50 ms (milliseconds). During this mold discharging time interval, any electrostatic charge present on the plastic sleeve 34 is effectively removed therefrom, so that the mold (together with the equipment mounted thereto) is then fully discharged and can be opened in the further flow of the process.

For an effective manufacturing process, a plurality of mold halves (together with their equipment mounted thereto) can be arranged in a carrier (not shown), which can be transported from one processing station to the next processing station. With the aid of this carrier the plurality of individual molds arranged in the carrier can all be transported beneath the discharging electrode 5, the charging electrode 6 and the further discharging electrode 8.

Although the invention has been described with reference to specific embodiments, it is evident to the person skilled in the art that this embodiment stands only by way of example for the general teaching underlying the present invention, and that various changes and modifications are conceivable without departing from that teaching. Therefore, the invention is not intended to be limited to the embodiments described, but rather its scope is defined by the appended claims.

1. A method for avoiding entrapment of air bubbles (5) in a lens forming material (4) in an ophthalmic lens manufacturing process using mold halves (2, 3) each having a lens forming surface (21, 31), said method including the step of providing an electrostatic charge (60) on a lens forming surface (21, 31) of at least one of said mold halves (2, 3) prior to said lens forming surface (21, 31) coming into contact with said lens forming material (4).

2. The method according to claim 1, wherein said at least one mold half is a female mold half (2) comprising a concavely shaped lens forming surface (21), and wherein said electrostatic charge (60) is provided on said concavely shaped lens forming surface (21) of said female mold half (2) prior to dispensing said lens forming material (4) into said female mold half (2).

3. The method according to claim 1, wherein said at least one mold half is a male mold half (3) comprising a convexly shaped lens forming surface (31), and wherein said electrostatic charge (60) is provided on said convexly shaped lens forming surface (31) of said male mold half (3) prior to advancing said male mold half (3) towards a female mold half (2) containing said lens forming material (4) for mating said male and female mold halves.

4. The method according to claim 2, wherein said at least one mold half is a male mold half (3) comprising a convexly shaped lens forming surface (31), and wherein said electrostatic charge (60) is provided on said convexly shaped lens forming surface (31) of said male mold half (3) prior to advancing said male mold half (3) towards a female mold half (2) containing said lens forming material (4) for mating said male and female mold halves.

5. The method according to claim 1, wherein said electrostatic charge (60) is provided on said lens forming surface (21, 31) of said at least one mold half (2, 3) by arranging said lens forming surface (21, 31) of said at least one mold half (2, 3) for a predetermined charging time interval at a predetermined distance (71) from a charging electrode (6) with said lens forming surface (21, 31) facing towards said charging electrode (6), with a DC voltage of a predetermined magnitude being applied to said charging electrode (6) to cause said electrostatic charge (60) to be provided on said lens forming surface (21, 31) of said at least one mold half (2, 3).

6. The method according to claim 4, wherein said electrostatic charge (60) is provided on said lens forming surface (21, 31) of said at least one mold half (2, 3) by arranging said lens forming surface (21, 31) of said at least one mold half (2, 3) for a predetermined charging time interval at a predetermined distance (71) from a charging electrode (6) with said lens forming surface (21, 31) facing towards said charging electrode (6), with a DC voltage of a predetermined magnitude being applied to said charging electrode (6) to cause said electrostatic charge (60) to be provided on said lens forming surface (21, 31) of said at least one mold half (2, 3).

7. The method according to claim 5, wherein said predetermined charging time interval is in the range of 0.1 s to 0.5 s, wherein said predetermined distance (71) from said charging electrode (6) is in the range of 10 mm to 20 mm, and wherein said predetermined magnitude of said DC voltage is in the range of 6 kV to 12 kV.

8. The method according to claim 5, wherein prior to arranging said lens forming surface (21, 31) for said predetermined charging time interval at said predetermined distance (71) from said charging electrode (6), said lens forming surface (21, 31) is arranged for a predetermined discharging time interval at a predetermined distance (70) from a discharging electrode (5) with said lens forming surface (21, 31) facing towards said discharging electrode (5), with an AC voltage of a predetermined magnitude being applied to said discharging electrode (5) to cause any electrostatic charges present on said lens forming surface (21, 31) to be removed from said lens forming surface (21, 31).

9. The method according to claim 7, wherein prior to arranging said lens forming surface (21, 31) for said predetermined charging time interval at said predetermined distance (71) from said charging electrode (6), said lens forming surface (21, 31) is arranged for a predetermined discharging time interval at a predetermined distance (70) from a discharging electrode (5) with said lens forming surface (21, 31) facing towards said discharging electrode (5), with an AC voltage of a predetermined magnitude being applied to said discharging electrode (5) to cause any electrostatic charges present on said lens forming surface (21, 31) to be removed from said lens forming surface (21, 31).

10. The method according to claim 9, wherein said predetermined discharging time interval is in the range of 0.01 s to 0.05 s, wherein said predetermined distance (70) from said discharging electrode (5) is in the range of 20 mm to 30 mm, and wherein said predetermined magnitude of said AC voltage is in the range of 4 kV to 10 kV.

11. The method according to claim 3, wherein during or after providing said electrostatic charge (60) on said convexly shaped lens forming surface (31) of said male mold half (3) said lens forming material (4) is dispensed into said female mold half (2), wherein said male mold half (3) is then advanced towards said female mold (2) half to close the mold, and wherein said closed mold is then arranged for a predetermined mold discharging time interval at a predetermined distance (72) from a further discharging electrode (8) with said closed mold facing towards said further discharging electrode (8), with an AC voltage of a predetermined magnitude being applied to said further discharging electrode (8) to cause any electrostatic charges present on said closed mold to be removed from said closed mold.

12. The method according to claim 4, wherein during or after providing said electrostatic charge (60) on said convexly shaped lens forming surface (31) of said male mold half (3) said lens forming material (4) is dispensed into said female mold half (2), wherein said male mold half (3) is then advanced towards said female mold (2) half to close the mold, and wherein said closed mold is then arranged for a predetermined mold discharging time interval at a predetermined distance (72) from a further discharging electrode (8) with said closed mold facing towards said further discharging electrode (8), with an AC voltage of a predetermined magnitude being applied to said further discharging electrode (8) to cause any electrostatic charges present on said closed mold to be removed from said closed mold.

13. The method according to claim 5, wherein said charging electrode (6) comprises an elongated charging bar (61) having a plurality of charging tips (62) arranged along the longitudinal extension of said charging bar (61) and projecting therefrom, and wherein the at least one mold half (2, 3) is moved along the longitudinal extension of said charging bar (61) with the lens forming surface (21, 31) of said at least one mold half (2, 3) facing towards the charging tips (62) of said charging bar (61).

14. The method according to claim 8, wherein the discharging electrode (5) comprises an elongated discharging bar (50) having a plurality of discharging tips (51) arranged along the longitudinal extension of said elongated discharging bar (50), and wherein the at least one mold half (2, 3) or said closed mold, respectively, are moved along the longitudinal extension of said elongated discharging bar (50) of said discharging electrode (5) with said lens forming surface (21, 31) of said at least one mold half (2, 3) or said closed mold facing towards the discharging tips (51) of said elongated discharging bar (50) of said discharging electrode (5).

15. The method according to claim 11, wherein the further discharging electrode (8) comprises an elongated discharging bar (80) having a plurality of discharging tips (81) arranged along the longitudinal extension of said elongated discharging bar (80), and wherein the at least one mold half (2, 3) or said closed mold, respectively, are moved along the longitudinal extension of said elongated discharging bar (80) of said further discharging electrode (8), with said lens forming surface (21, 31) of said at least one mold half (2, 3) or said closed mold facing towards the discharging tips (81) of said elongated discharging bar (80) of said further discharging electrode (8).

16. The method according to claim 1, wherein said at least one mold half (2, 3) is made of glass or quartz glass.

17. An apparatus for avoiding entrapment of air bubbles (5) in a lens forming material (4), in an ophthalmic lens manufacturing process, the apparatus comprising a charging electrode (6) and at least one mold half (2, 3) having a lens forming surface (21, 31), said charging electrode (6) and said lens forming surface (21, 31) being arranged relative to each other in a manner such that during a predetermined charging time interval said lens forming surface (21, 31) is arranged at a predetermined distance (71) from said charging electrode (6) with said lens forming surface (21, 31) facing towards said charging electrode (6), with a DC voltage of a predetermined magnitude being applied to said charging electrode (6) to cause said electrostatic charge (60) to be provided on said lens forming surface (21, 31) of said at least one mold half (2, 3).

18. An apparatus according to claim 17, further including a carrier for said at least one mold half (2, 3), a transport system for moving the carrier, and a discharging electrode (5), the discharging electrode (5) being arranged upstream of said charging electrode (6) with respect to a direction of transport of said carrier with said transport system, with an AC voltage being applied to said discharging electrode (6), said discharging electrode (6) being arranged in a manner such that, during transport of said carrier said lens forming surface (21, 31) is arranged during a predetermined discharging time interval at a predetermined distance (70) from said discharging electrode (5), with said lens forming surface (21, 31) facing said discharging electrode (5) to cause any electrostatic charges present on said lens forming surface (21, 31) to be removed from said lens forming surface (21, 31), and that during further transport of said carrier said lens forming surface (21, 31) is arranged during said charging time interval at said predetermined distance (71) from said charging electrode (6), with said lens forming surface (21, 31) facing towards said charging electrode (6) to cause said electrostatic charge (60) to be provided on said lens forming surface (21, 31).

19. The apparatus of claim 18, including a further discharging electrode (8) which is arranged downstream of said charging electrode (6) with respect to said direction of transport of said carrier with said transport system, with an AC voltage being applied to said further discharging electrode (8), said further discharging electrode (8) being arranged in a manner such that after providing said electrostatic charge (60) on said lens forming surface (21, 31) on said at least one mold half (2, 3) and after mating said at least one mold half with the electrostatic charge provided thereon with an associated further mold half to form a closed mold, the closed mold is arranged during a predetermined mold discharging time interval at a predetermined distance (72) from said further discharging electrode (8), with said closed mold facing towards said further discharging electrode (8) to cause any electrostatic charge to be removed from the closed mold.
